(19) United States
(12) Patent Application Publication
(10) Pub. No.: US 2026/0302581 A1
(43) Pub. Date: Oct. 1, 2026

(54) PHASE SHIFTER TUNING USING DISCRETE SWITCHABLE OPEN STUBS

(71) Applicant: Dell Products L.P., Round Rock, TX (US)

(72) Inventors: Tejinder Singh, Manotick (CA); Navjot Kaur Khaira, Manotick (CA)

(21) Appl. No.: 19/091,553

(22) Filed: Mar. 26, 2025

(51) Int. Cl. H01P 1/18

(52) U.S. Cl. CPC H01P 1/18; H01P 1/184

(57) ABSTRACT

The technology described herein is directed towards a tunable phase device including true time delay transmission lines and open stub capacitors, with switches that control the coupled or decoupled states of selectable true time delay transmission lines and open stub capacitors with respect to a transmission line, e.g., connected in a coplanar waveguide configuration. In one example implementation, the phase shifter device includes four true time delay transmission lines and eighteen open stubs, controllably coupled or decupled by ten multistate (single pole, three throw) RF switches. The multistate switches can include phase-change material-based junctions, whereby a controller can select the operating phase of the device by determining the conductive or non-conductive state of each switch junction by applying a set or reset pulse to a heating element associated with that junction. In one implementation, this switch control facilitates analog type phase tuning with ultra-precise, fine, and coarse step tuning.

### RELATED APPLICATION

The subject patent application is related to U.S. patent application Ser. No. ______, filed ______, entitled “SWITCHED CAPACITOR BANK UTILIZING OPEN-STUB TRANSMISSION LINES” (docket no. 141960.01/DELLP1559US), the entirety of which patent application is hereby incorporated by reference herein.

### BACKGROUND

Phase shifters control the phase of radio frequency (RF) signals for applications like beamforming and signal synchronization. Phase shifters are used in phased arrays, beamforming, radar, satellite communication, and 5G networks for precise signal control. Types of phase shifters include analog phase shifters that continuously adjust the phase using components like varactors, digital phase shifters that offer discrete phase shifts using switches like PIN diodes or microelectromechanical systems (MEMS) switches, and mechanical phase shifters, which adjust phase through physical changes in the signal path.

### BRIEF DESCRIPTION OF THE DRAWINGS

The technology described herein is illustrated by way of example and not limited to the accompanying figures in which like reference numerals indicate similar elements and in which:

FIG. 1 is a top two-dimensional (2D) view representation of an example system including a tunable phase shifter device controlled by a controller, in accordance with various example embodiments and implementations of the subject disclosure.

FIG. 2 is a top 2D view representation of the example tunable phase shifter device depicted as separated into various sections, in accordance with various example embodiments and implementations of the subject disclosure.

FIG. 3 is a top 2D view representation of the example tunable phase shifter device implemented in a chip design, in accordance with various example embodiments and implementations of the subject disclosure.

FIG. 4 is a top three-dimensional (3D) view of the example device of FIG. 3 atop a substrate, in accordance with various example embodiments and implementations of the subject disclosure.

FIG. 5A is a zoomed-in representation of an example contact pad region of FIG. 4, in accordance with various example embodiments and implementations of the subject disclosure.

FIG. 5B is a zoomed-in representation of an example switch region of FIG. 4, in accordance with various example embodiments and implementations of the subject disclosure.

FIG. 6A is a top view representation of an example layout of a switch with phase change material (PCM) switch junctions, in accordance with various example embodiments and implementations of the subject disclosure.

FIG. 6B is a top 3D representation of an example layout of a switch with phase change material (PCM) switch junctions, in accordance with various example embodiments and implementations of the subject disclosure.

FIG. 7 is a top view representation of a multistate RF switch showing RF input that can be coupled to any of or all of three possible outputs, in accordance with various example embodiments and implementations of the subject disclosure.

FIG. 8 is a 3D representation of an example model for the phase shifter device, including a zoomed in portion of one switch, in accordance with various example embodiments and implementations of the subject disclosure.

FIG. 9 is a 3D representation showing details of an example switch junction, in accordance with various example embodiments and implementations of the subject disclosure.

FIG. 10A is a 3D representation corresponding to the example switch junction of FIG. 9, in accordance with various example embodiments and implementations of the subject disclosure.

FIG. 10B is a 3D representation of an example switch, such as one incorporating the example switch junction of FIG. 9, in accordance with various example embodiments and implementations of the subject disclosure.

FIGS. 11A, 11B, 12A and 12B are representations of electric field (E-field) depictions resulting from various example operational states of the example phase shifter device, in accordance with various example embodiments and implementations of the subject disclosure.

FIGS. 13A and 13B are graphical representations of simulated phase shift results, and return loss and insertion loss results, for the example operational state of 11A, in accordance with various example embodiments and implementations of the subject disclosure.

FIGS. 14A and 14B are graphical representations of simulated phase shift results, and return loss and insertion loss results, for the example operational state of 11B, in accordance with various example embodiments and implementations of the subject disclosure.

FIGS. 15A and 15B are graphical representations of simulated phase shift results, and return loss and insertion loss results, for the example operational state of 12A, in accordance with various example embodiments and implementations of the subject disclosure.

FIGS. 16A and 16B are graphical representations of simulated phase shift results, and return loss and insertion loss results, for the example operational state of 12B, in accordance with various example embodiments and implementations of the subject disclosure.

FIG. 17 is a top three-dimensional (3D) view representation of an example capacitor bank in the form of variable capacitive device with operational capacitance controlled by a controller, in accordance with various example embodiments and implementations of the subject disclosure.

FIG. 18 is a top 3D view representation of example capacitors of a capacitive device model, in accordance with various example embodiments and implementations of the subject disclosure.

FIG. 19 is a representation of a zoomed in portion of FIG. 18 showing open stub capacitors of an example capacitive device model, in accordance with various example embodiments and implementations of the subject disclosure.

FIG. 20 is a top two-dimensional (2D) view of a scattering parameter (S-parameter) model of example capacitors of a capacitive device, in accordance with various example embodiments and implementations of the subject disclosure.

FIGS. 21A, 21B and 22 are graphical representations of simulated return loss, insertion loss, and phase shift, respectively, of a various example operational states of the example capacitive device model, in accordance with various example embodiments and implementations of the subject disclosure.

FIG. 23 is a flow diagram showing example operations related to electrically coupling RF signals to selectable phase shift transmission lines and true time delay transmission lines of a phase shifter device, in accordance with various aspects and implementations of the subject disclosure.

### DETAILED DESCRIPTION

Various implementations and embodiments of the technology described herein are generally directed towards a tunable phase shifter radio frequency (RF) phase shifter device that facilitates controlled selection of various true time delay transmission lines and/or open stub capacitors, including in various combinations, to obtain a specified operational phase shift of the device. Example usages of the tunable phase shifter RF device include, but are not limited to, use in phased arrays, beamforming, radar, satellite communication, and 5G networks for precise signal control. As will be understood, the device facilitates more than suitable phase range, insertion loss, phase accuracy, return loss, power handling, and switching speed, which ensure performance and efficiency.

In one implementation, described is tunable phase shifter utilizing ten multistate RF switches (e.g., single-pole, three-throw (SP3T) switches) that enable the selection of multiple (e.g., four) true time delay transmission lines, and multiple (e.g., eighteen) distinct open stub capacitors connected to a co-coplanar waveguide (CPW) line. This configuration facilitates maintaining high flexibility and scalability while ensuring low insertion loss, e.g., across the C-band. By selectively activating a single switch or a combination of multiple states of the multistate RF switches, the tunable phase shifter device provides a relatively large number of selectable operational phase shifts, allowing dynamic tuning of the tunable phase shifter for many possible uses. One result is a compact phase shifter device design.

In one implementation, the switches include respective phase-change material junctions (e.g., Germanium telluride (GeTe)/chalcogenide material) that can be controlled into a conductive state or a nonconductive state based on heat applied via energy pulses to respective heating elements associated with the respective junctions. This allows coupling or decoupling any of the true time delay transmission lines or open stubs to the RF transmission line, thereby resulting in a specified phase shift based on which true time delay transmission lines or open stubs are coupled, and which are decoupled.

The design of the tunable phase shifter device facilitates a compact, cost-effective, and well-suited device for applications in tunable RF systems and adaptive filters. Note that while the example design described with respect to the example implementation is designed for C-band devices, the tunable capacitive device can be scaled as appropriate for other frequency bands.

Reference throughout this specification to “one embodiment,” “an embodiment,” “one implementation,” “an implementation,” etc. means that a particular feature, structure, characteristic and/or attribute described in connection with the embodiment/implementation can be included in at least one embodiment/implementation. Thus, the appearances of such a phrase “in one embodiment,” “in an implementation,” etc. in various places throughout this specification are not necessarily all referring to the same embodiment/implementation. Furthermore, the particular features, structures, characteristics and/or attributes may be combined in any suitable manner in one or more embodiments/implementations. Repetitive description of like elements employed in respective embodiments may be omitted for sake of brevity.

The detailed description is merely illustrative and is not intended to limit embodiments and/or application or uses of embodiments. Furthermore, there is no intention to be bound by any expressed or implied information presented in the preceding sections, or in the Detailed Description section. Further, it is to be understood that the present disclosure will be described in terms of a given illustrative architecture; however, other architectures, structures, materials and process features, and steps can be varied within the scope of the present disclosure.

It also should be noted that terms used herein, such as “optimize,” “optimization,” “optimal,” “optimally” and the like only represent objectives to move towards a more optimal state, rather than necessarily obtaining ideal results. Similarly, “maximize” means moving towards a maximal state (e.g., up to some practical limit), not necessarily achieving such a state, and so on.

It will also be understood that when an element such as a layer, region or substrate is referred to as being “on” or “over” “atop” “above” “beneath” “below” and so forth with respect to another element, it can be directly on the other element or intervening elements can also be present. In contrast, only if and when an element is referred to as being “directly on” or “directly over” another element, are there no intervening element(s) present. Note that orientation is generally relative; e.g., “on” or “over” can be flipped, and if so, can be considered unchanged, even if technically appearing to be under or below/beneath when represented in a flipped orientation. It will also be understood that when an element is referred to as being “connected” or “coupled” to another element, it can be directly connected or coupled to the other element or intervening elements can be present. In contrast, only if and when an element is referred to as being “directly connected” or “directly coupled” to another element, are there no intervening element(s) present.

The following detailed description is merely illustrative and is not intended to limit embodiments and/or application or uses of embodiments. Furthermore, there is no intention to be bound by any expressed or implied information presented in the preceding sections, or in the Detailed Description section.

One or more example embodiments are now described with reference to the drawings, in which example components, graphs and/or operations are shown, and in which like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details, and that the subject disclosure may be embodied in many different forms and should not be construed as limited to the examples set forth herein.

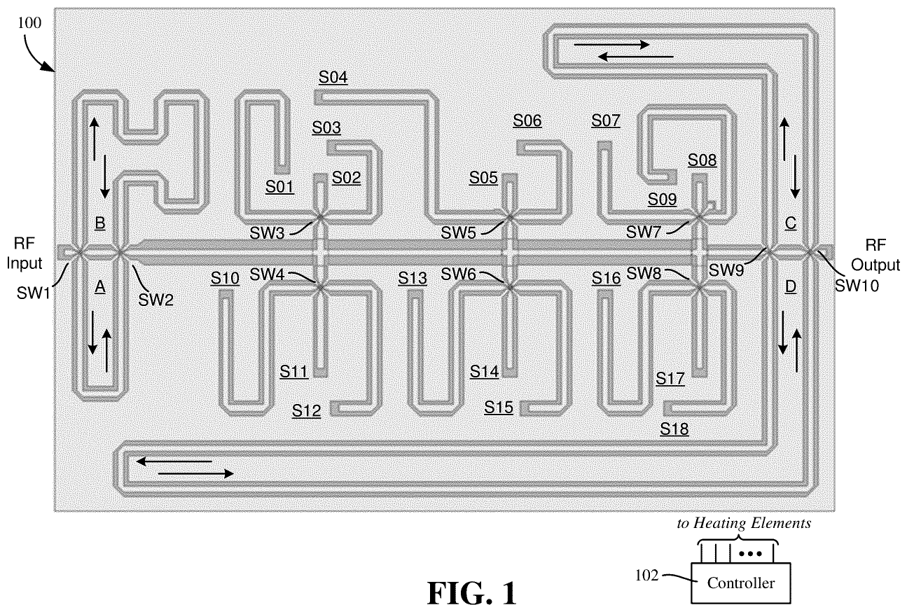

FIG. 1 shows a phase shifter device 100 integrating true time delay transmission lines A-D with phase-change multistate RF switches SW1-SW10 utilizing phase change (e.g., nonvolatile Germanium telluride, GeTe) material. A controller 102 controls the state of the multistate RF switches, which in this example are single-pole, three-throw (SP3T) switches. In one implementation, the phase shifter device 100 is a monolithically integrated design that utilizes switched true time delay transmission lines and switched open stubs S1-S18, while offering analog-like phase tuning by offering ultra-precise, fine, and coarse step tuning.

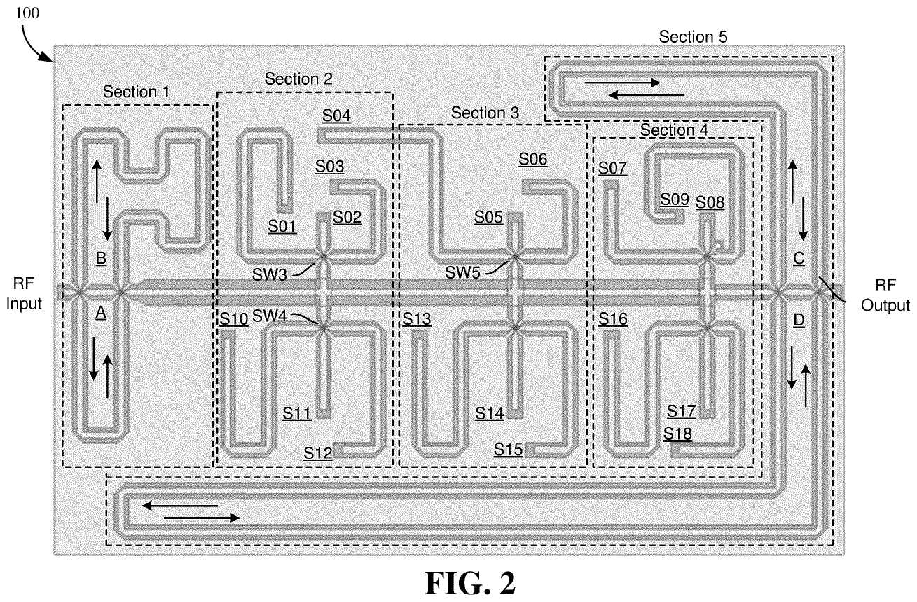

As shown in FIG. 2, the phase shifter 100 includes two fixed true time delay transmission lines (A and B) connected by back-to-back SP3T switches in a first section, Section 1, followed by three sections (Section 2, Section 3 and Section 4) in series, each containing six open-stubs linked to SP3T switches. For example, Section 2 has three stubs S01, S02 and S03 lined to SP3T switch SW3, and three stubs S10, S11 and S12 lined to SP3T switch SW4. A final stage, Section 5, with TTD transmission lines (C and D) provides additional phase control.

In this example, if coupled to the signal path, the transmission lines A, B, C, and D provide phase shifts of 20°, 40°, 60°, and 120°, respectively; the arrows near the A, B, C, and D labels shows the direction of the signal through the transmission lines A, B, C, and D when included in the signal path. The SP3T switches SW1-SW10 utilize phase-change RF switches based on GeTe, ensuring nonvolatile state retention and fast switching. The modular design supports scalable phase shifts for complex beamforming networks. The ultra-precise, fine, and coarse step tuning are facilitated by cascading the five sections, include the three stub sections Section 2, Section 3 and Section 4), together. Two fixed true time delay transmission lines provide a larger phase offset. This architecture achieves configurable phase shifts through back-to-back SP3T switches and multiple open-stub sections. The design offers precise phase control with low insertion loss, compactness, and high reliability, addressing challenges in modern phased array and beamforming applications.

Thus, as shown in FIG. 2, Section 1 has two fixed true time delay transmission lines (A, B), Section 2 has six stubs (S01, S02, S03, S10, S11 and S12), Section 3 has six stubs (S04, S05, S06, S13, S14 and S15), Section 4 has six stubs (S07, S08, S09, S16, S17, S18), and Section 5 has two true time delay transmission lines (C, D). Note that part of the open stub S04 extends into what is outlined as Section 2, but is considered part of Section 3 because it is coupled to the SP3T switch SW5 that controls the open stubs S04, S05 and S06.

In general, phase shifters can be used for applications, such as in C-Band RF hardware for use in radios, satellite communication, radar, 5G infrastructure, filters, and power amplifiers. Traditional phase shifters face limitations in terms of precision, compactness, and switching speed; analog solutions struggle with stability, while digital approaches often incur higher insertion loss. Existing designs also lack the ability to provide consistent non-volatile phase states, as appropriate for high-reliability systems like 5G networks, satellite communication, and radar. Existing phase shifters include analog designs using tunable components like varactors, which provide continuous phase shifts but suffer from instability and high-power consumption. Digital phase shifters with PIN diodes or MEMS switches offer discrete phase shifts but often face higher insertion loss and slower switching. MEMS-based solutions provide good isolation and low loss but are limited by mechanical fragility and slower response times, making them less suitable for high-reliability and compact modern RF systems. In contrast, the technology described herein offers relatively precise phase control with low insertion loss, compactness, and high reliability, addressing challenges in modern phased array and beamforming applications.

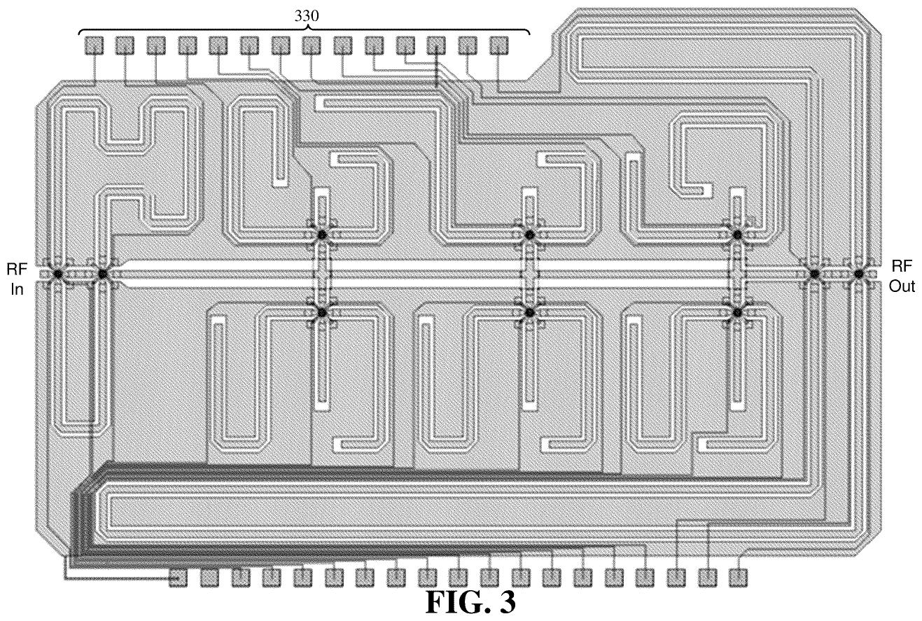

FIG. 3 shows an example layout of a chip that is suitable for implementing the phase shifter device 100. This includes some of the contact pads (collectively labeled 330) by which the controller 102 individually controls the states of the multistate switches SW1-SW10.

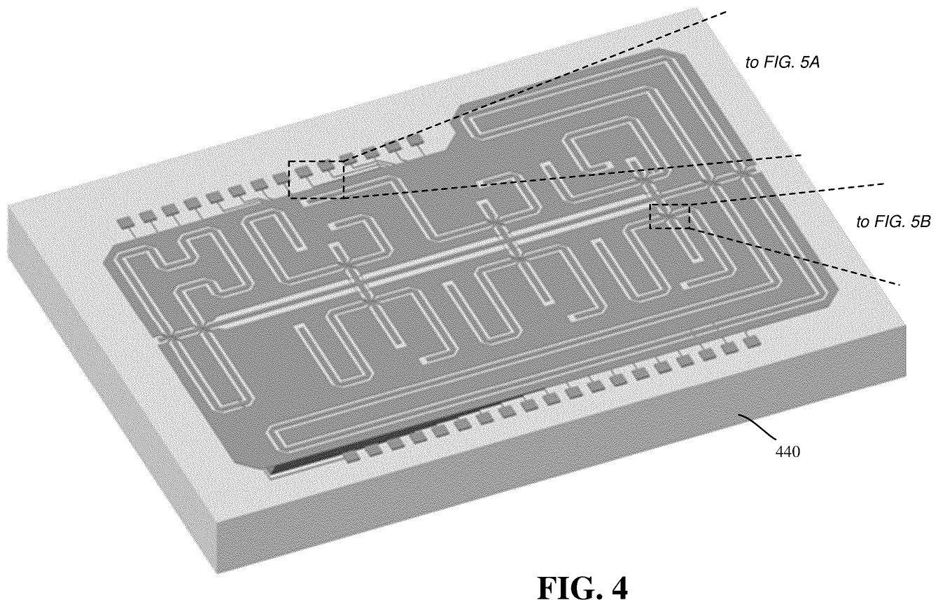

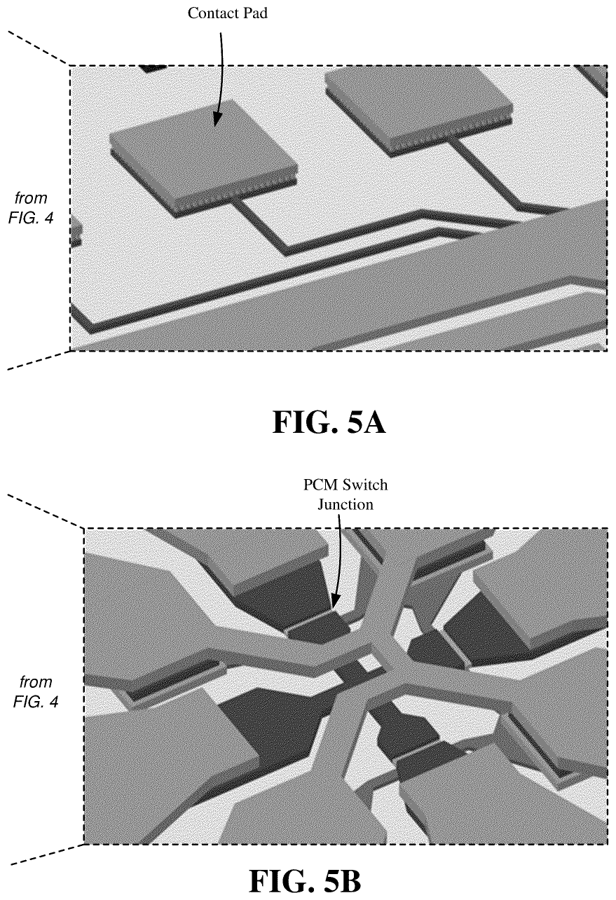

FIG. 4 is a three-dimensional (3D) view of the device built on a substrate 440. A portion of FIG. 4 showing a portion of the contact pads region is shown in the enlarged view of FIG. 5A. Another portion of FIG. 4, showing a switch, is shown in the enlarged view of FIG. 5B.

Turning to the multistate switches, in general, switches control the routing of RF signals in communication systems, and for example can be used for tasks like antenna selection and signal path switching. Common types of RF switches include PIN diodes, FET (field effect transistor)/GaN (Gallium Nitride) switches, and MEMS (micro-electromechanical systems) switches, each with different characteristics in terms of speed, power consumption, and performance. RF switches are used in devices such as mobile phones, base stations, and phased array antennas for tasks like signal routing, antenna switching, and phase shifting.

With phase change material switches useable in one or more implementations described herein, the controller selectively applies a set voltage or current pulse or a reset voltage or current pulse to each heating element to determine whether the phase change material junction associated with that heating element is in a conductive state or a nonconductive state, respectively. Notwithstanding, other types of switches can be used.

For the phase change material switches, chalcogenide material is formed with alloys containing group VI elements such as sulfur(S), selenium (Se) and telluride (Te). Among these, the alloys formed from different ratio combinations of germanium, antimony, and telluride (Ge—Sb—Te, or GST alloys) are currently the most popular for radio frequency and optical memory applications. In general, single-phase alloys are made of germanium telluride (GeTe) and antimony telluride (Sb2Te3). Alloys include Ge1Sb2Te4, Ge2Sb2Te5, and GelSb4Te7. Depending on the alloy used, the properties range from high stability and low speed to low stability and high speed. The GST alloys have a unique property of reversibly switching between amorphous and crystalline states upon specific heat treatment by means of electrical pulses, hence the name “phase-change.” The state in which atoms are arranged in a disorderly manner (short range order) is called the amorphous state, whereas the state where atoms are organized in an orderly manner (long range order) is called crystalline state. The disordered amorphous state has a lower mean free path of conduction for electrons that impedes current flow due to electron scattering, thus resulting in a higher resistance when compared to the crystalline state.

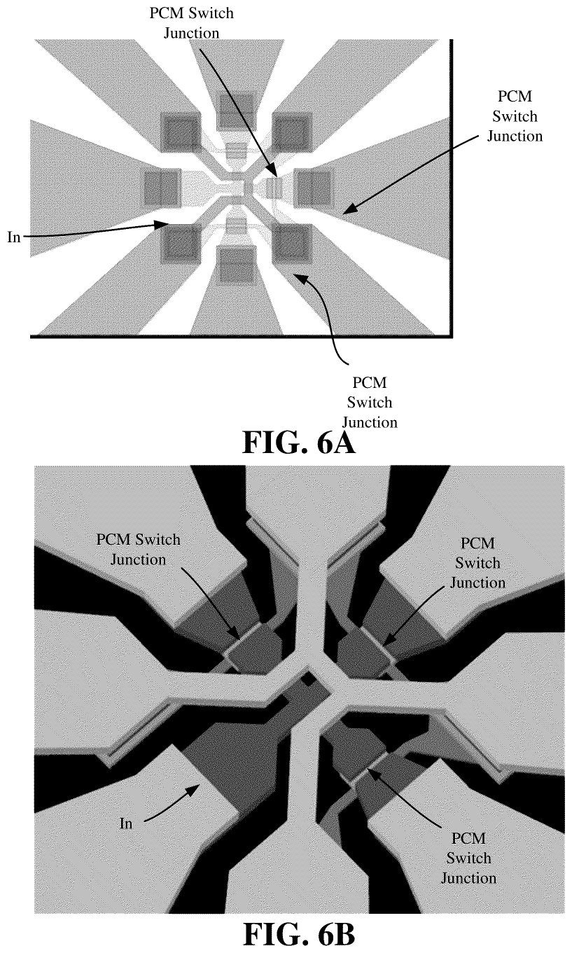

In an implementation in which phase change material switches are employed, such as in FIGS. 5B-6B, (in which FIG. 6A depicts a top view of switch layout, and FIG. 6B is a top view of a switch), the conductive or nonconductive states of phase change material (PCM) switch junctions are individually controlled by the controller. The operation principle of the example multistate switches is based on the many orders of magnitude resistance change that chalcogenide phase change GST alloys undergo when provided a specific heat treatment using an energy pulse. Such materials can reversibly transition between a low resistance (metallic/conductive) state to a high resistance (insulator/resistive) state. This transition occurs due to the change in crystal structure of the alloy, which changes from amorphous to crystalline. In order to control the states of the material, a heater network has heating elements placed proximate to the phase change material (chalcogenide material) junctions. In general, a set pulse (to transition to the conductive state) has a relatively lower voltage than the reset pulse (to transition to the nonconductive state), with the set pulse applied for a longer time than the reset pulse. Significantly, once transitioned to the conductive state or the nonconductive state, the phase change material is latched in that state, meaning no power is needed to maintain that state, resulting in a low-power device that only needs energy if and when transitioning between states.

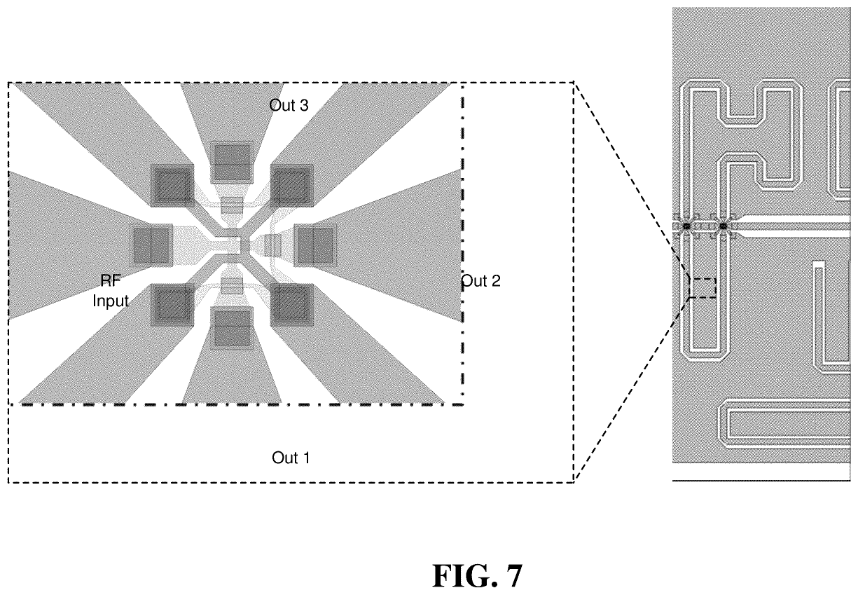

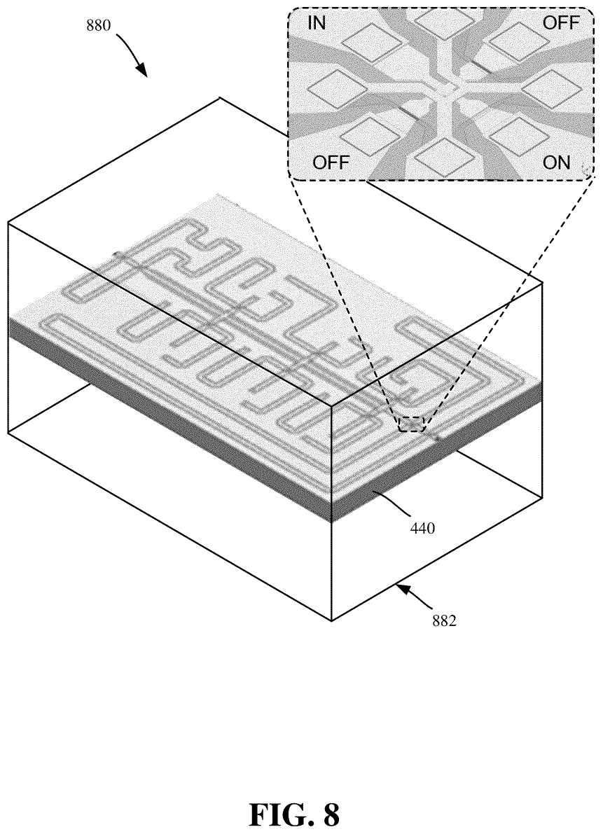

FIG. 7 shows a SP3T RF switch with RF input at the single pole, and three switch outputs (Out 1-Out 3) at the three throws, respectively, which can be individually coupled to or decoupled from the RF signal at the RF input. For example, with three open stubs coupled to Out 1-Out 3, the controller individually sets the state of each PCM switch junctions to either exclude the stub, or to not couple the stub to the RF input at the pole at the RF input (pole). For example, as shown in the enlarged portion of FIG. 8, one of the stubs (ON) is coupled to the input (IN), while the others are decoupled from the input (OFF).

FIG. 8 shows a 3D model 880 for electromagnetic (EM) simulation, such as in Ansys HESS (High-Frequency Structure Simulator), in which the device 100 is atop the substrate 440, within an air box 882. As set forth herein, the enlarged view of the switch shows two switch junctions, two of which result in the true time delay transmission lines being “OFF”, and one switch junction coupling to a true time delay transmission is in use, in an “ON” state.

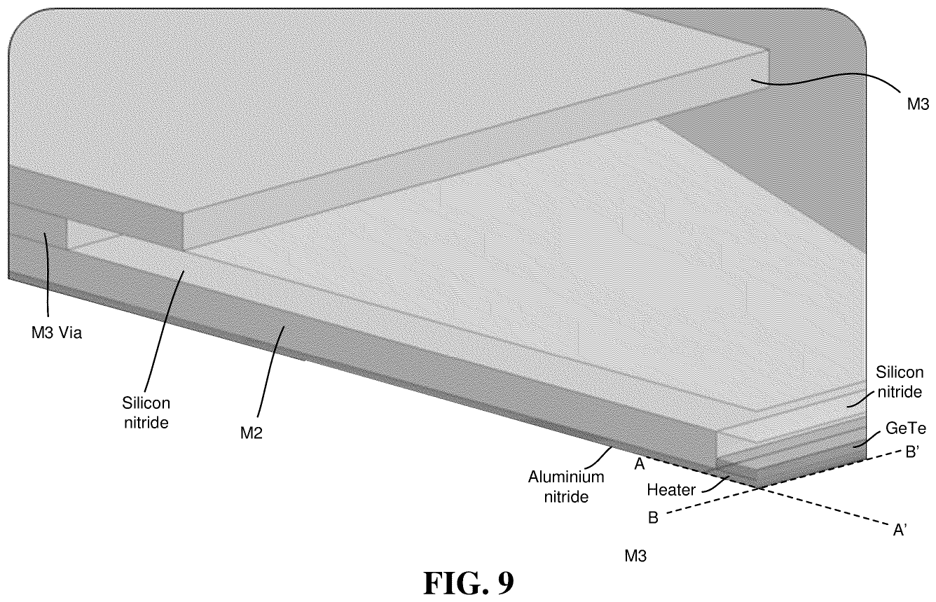

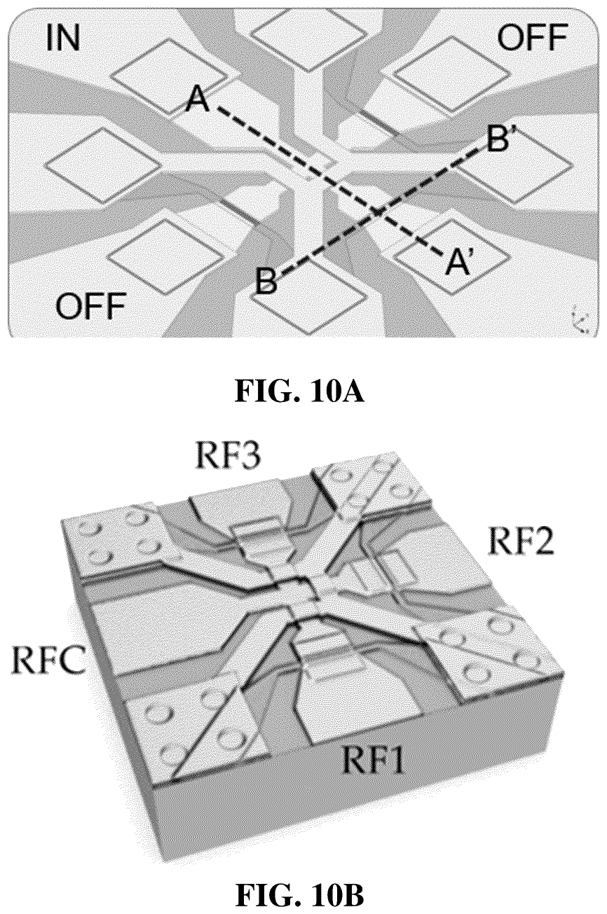

FIG. 9 shows details of one example switch junction, including the GeTe material atop a heater/aluminum nitride, and below a silicon nitride layer. Also shown metal layers M2 and M3, and an M3 via. It is understood that these layers are above a substrate. Also note that the dashed lines A to A′ and B to B′ are shown enlarged in FIG. 10A, in which A to A′ is the RF signal path to the “ON” true time delay transmission lines, around the B to B′ switch junction. FIG. 10 B shows a 3D view of the switch, where “RFC” represents the RF input (common port).

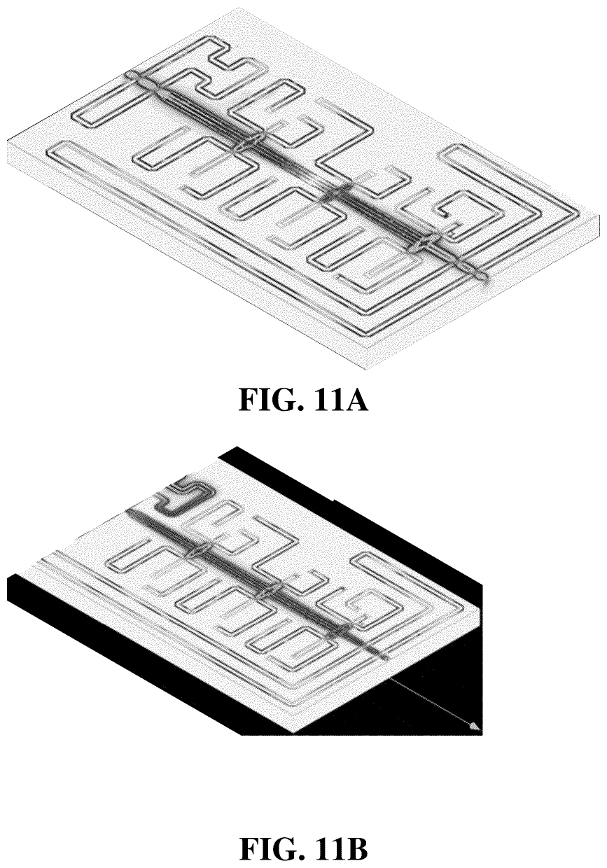

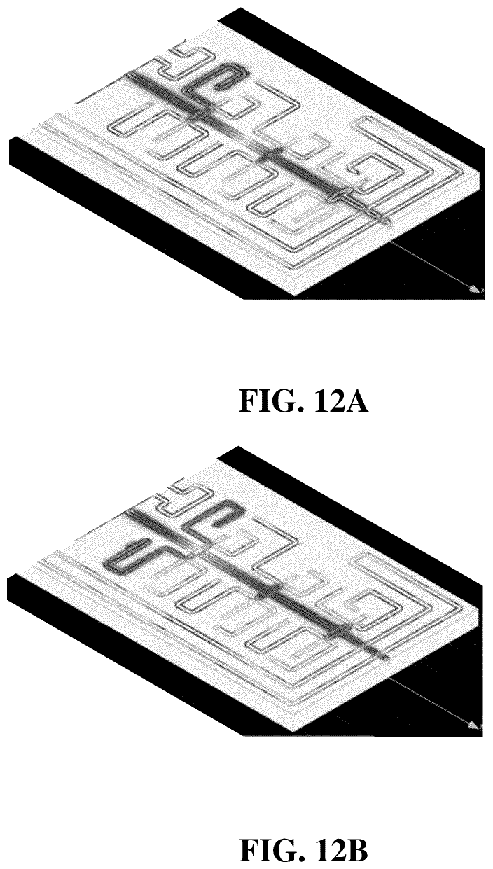

FIGS. 11A, 11B, 12A and 12B show the electric field (E-field, with the E Field scale from 0 to 1e5 Volts/meter) in four different operational states as controlled by the controller via switch control. In particular, FIG. 11A shows an operational reference state with virtually zero phase shift due to the states of the four inline switches not coupling the RF signal to any true time delay transmission line, nor to any open stub. FIG. 11B shows a +80 degree phase shift operational state (S_01) resulting from one of the four inline switches coupling the RF signal to a true time delay transmission line (e.g., line B, FIG. 2). FIG. 12A shows another operational state, (S_02), obtained via a stub coupled to interact with the RF signal, stub/capacitor S01, and FIG. 12B shows yet another operational state, (S_03) with two stubs coupled to interact with the RF signal, namely stub/capacitor S01 and stub/capacitor S10.

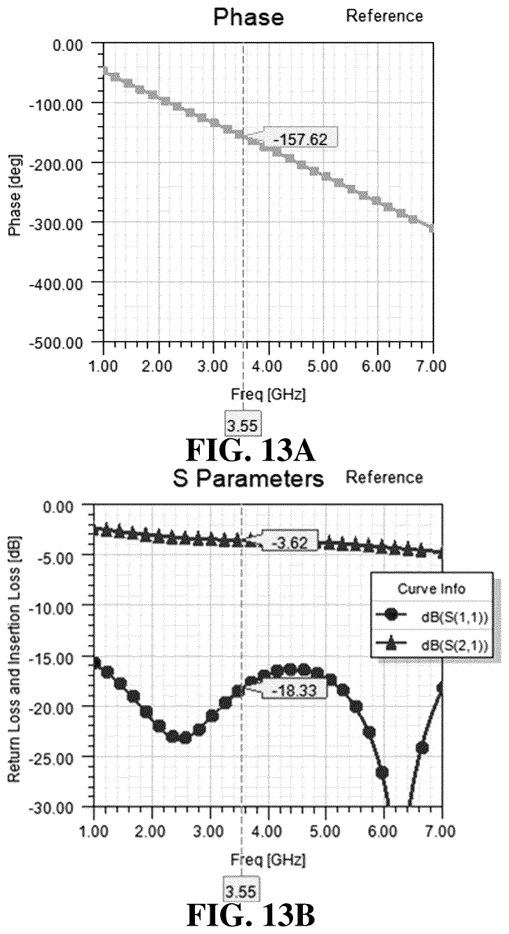

FIGS. 13A and 13B show simulation results for the reference state of FIG. 11A. The phase shift (in degrees) is shown in FIG. 13A, and the scattering parameters (S-parameters) shown in FIG. 13B, where S11 shows the return loss (in dB), and S21 shows the insertion loss (in dB).

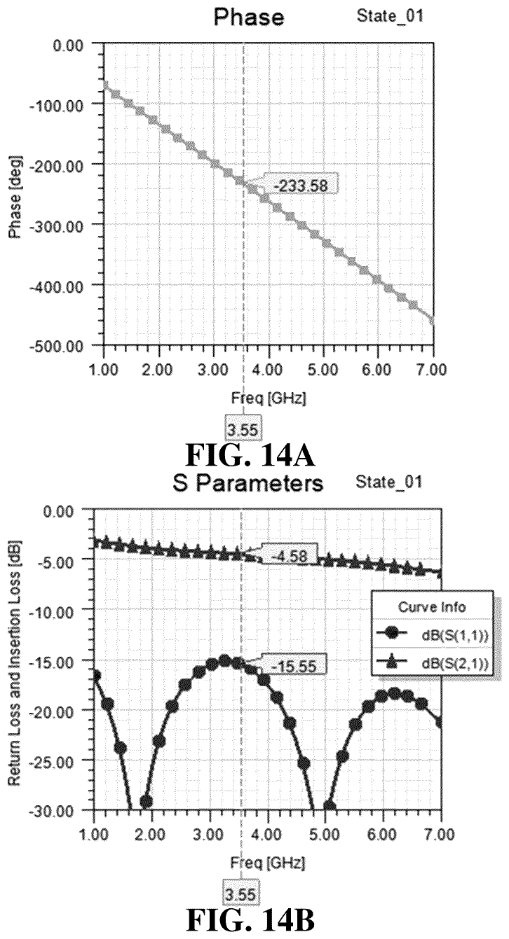

FIGS. 14A and 14B show simulation results for the state S_01 state of FIG. 11B. The phase shift (in degrees) is shown in FIG. 14A, and the scattering parameters (S-parameters) shown in FIG. 14B, where S11 shows the return loss (in dB), and S21 shows the insertion loss (in dB).

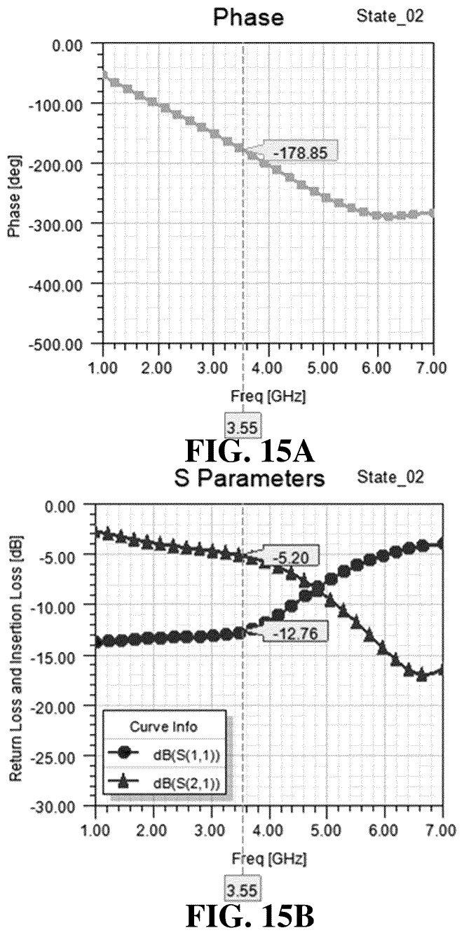

FIGS. 15A and 15B show simulation results for the state S_02 state of FIG. 12A. The phase shift (in degrees) is shown in FIG. 15A, and the scattering parameters (S-parameters) shown in FIG. 15B, where S11 shows the return loss (in dB), and S21 shows the insertion loss (in dB).

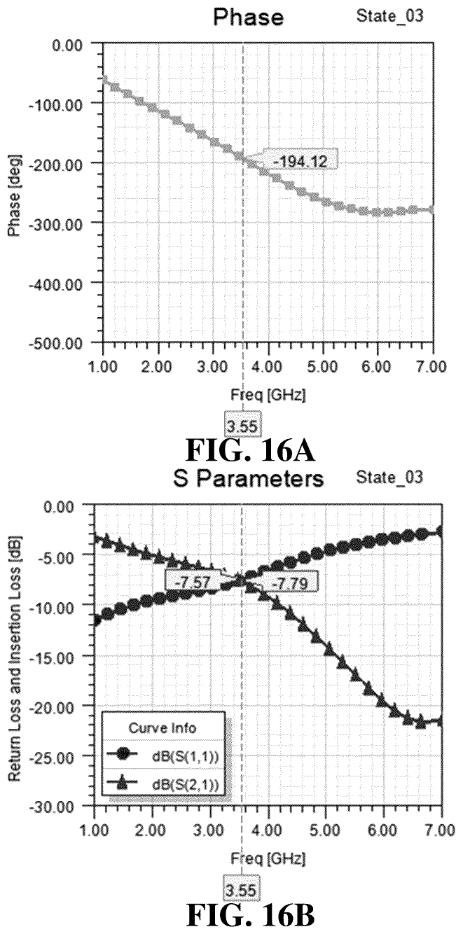

FIGS. 16A and 16B show simulation results for the state S_03 state of FIG. 12B. The phase shift (in degrees) is shown in FIG. 16A, and the scattering parameters (S-parameters) shown in FIG. 16B, where S11 shows the return loss (in dB), and S21 shows the insertion loss (in dB).

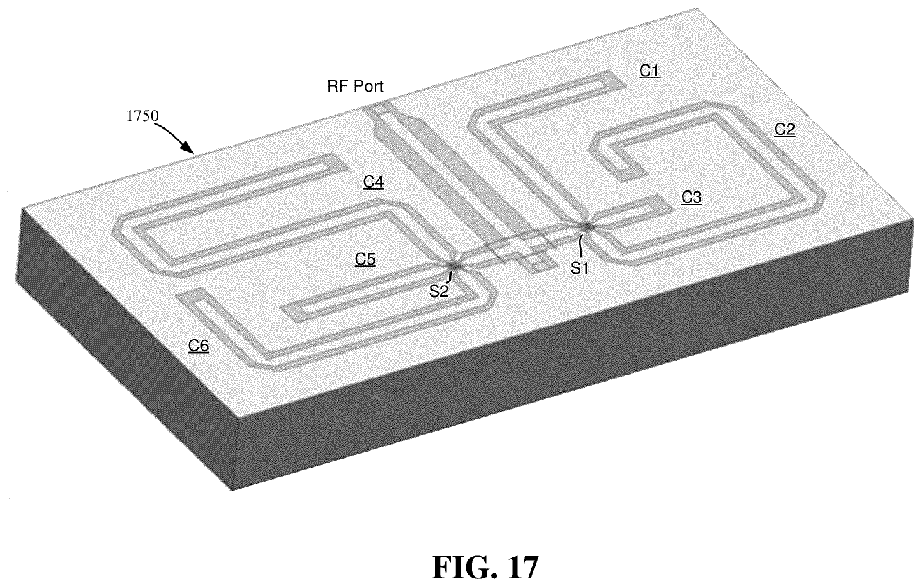

For purposes of explanation, six open stub capacitors, e.g., implemented as a section, can be described with reference to a capacitor bank (FIG. 17) with a multistate (SP3T) switch that controls the open stub capacitors, e.g., connected in a single-port coplanar waveguide configuration. The capacitor bank achieves high configurability without relying on grounded coplanar waveguide designs. By allowing any combination of the N capacitors to be activated independently or simultaneously, each capacitor bank design enables 2N selectable states, where each state corresponds to a specific capacitance or combination of capacitances.

More particularly, FIG. 17 is a representation of a single tunable (variable) capacitive device 1750 (a capacitor bank) in which the operational capacitance of each such tunable capacitive device 1750 is controlled by the controller as described herein. In this example, the tunable capacitive device 1750 includes six open stub capacitors C1-C6 and two multistate switches S1 and S2, which in this example are single pole, three throw RF switches; open stub capacitors use transmission line stubs to create capacitance. The states of the multistate switches S1 and S2 determine which (if any) open stub capacitors are coupled to the RF transmission line and thereby interact with RF signals thereon, or which are decoupled. As is seen in FIG. 17, the lengths of the six capacitors C1-C6 are each different from one another, and thereby have different capacitance values from one another. The following table, TABLE 1, shows capacitance values for six capacitors configured as the capacitor bank of FIG. 1 in one example implementation:

TABLE 1
Capacitors

C1 = 300 fF
C2 = 40 fF
C3 = 650 fF
C4 = 728 fF
C5 = 130 fF
C6 = 400 fF

Note that in general, capacitor banks are used for frequency control and tunability in various RF applications. Capacitor banks configurations for RF systems include series-parallel combinations and integrated designs, which helps to ensure wide tunability and compactness in telecommunications applications. Capacitor performance metrics include capacitance range, quality factor (Q-factor), self-resonant Frequency, power handling, and RF insertion loss define performance in high-frequency systems.

Typical capacitor banks are designed by integrating a multi-throw switch and either commercial off-the-shelf (COTS) capacitors or integrated metal-insulator-metal (MIM) capacitors. COTS are easy to implement, but the variation in performance is only useful for low-frequency applications. The MIM solution offers a high capacitance ratio per area, but usually has a poor Q-factor due to the large size of capacitors. Traditional designs, which often rely on fixed capacitor arrays or bulky mechanical tuners, are inherently limited in flexibility and scalability. Some modern solutions utilizing semiconductor switches have attempted to address these issues but still face significant challenges. These include limited configurability due to fixed-state designs, high insertion loss as the number of capacitors and switches increases, and complex control schemes that complicate the management of multiple switching states.

In contrast, the technology described herein can be based on scalable, low-loss, and reconfigurable capacitor banks that offer a relatively large number of operational states while maintaining compactness and performance. In tunable RF systems, the technology described herein can achieve high configurability and compactness in capacitor banks, highly suitable for effective impedance matching and frequency-selective tuning, particularly in bands such as the C-band.

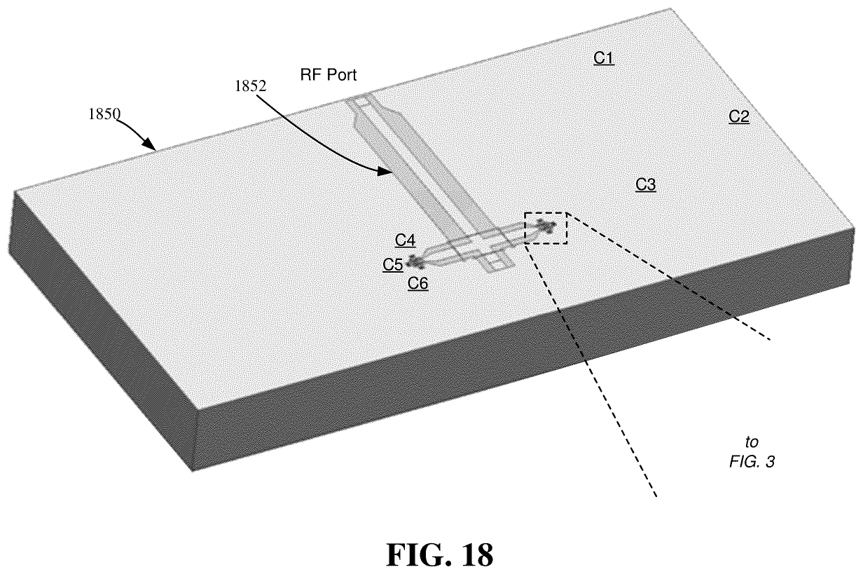

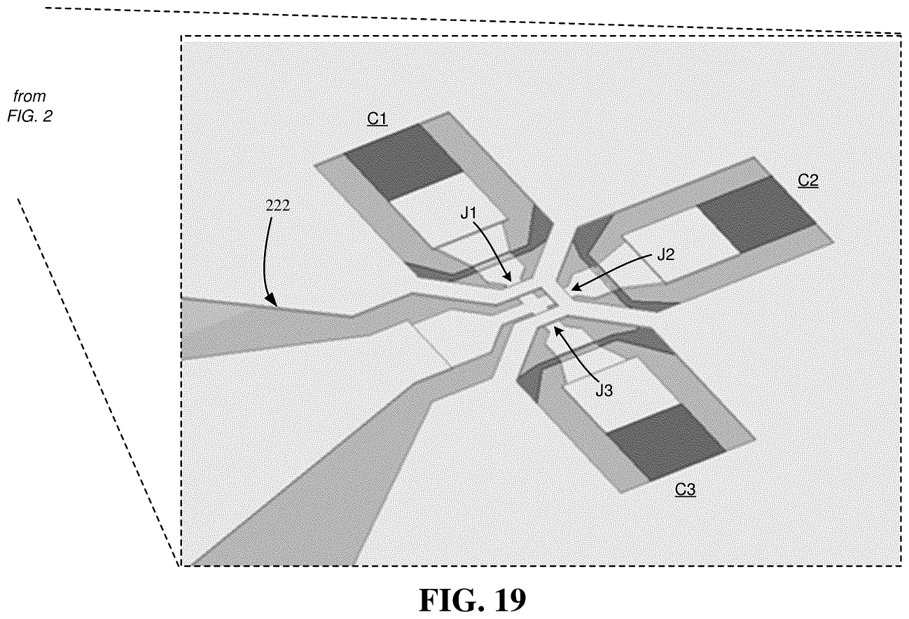

FIGS. 18 and 19 show a similar device 1850 with a relatively longer split transmission line 18524) (configured as a coplanar waveguide) compared to the area covered by the open stub capacitors C1-C6 in FIG. 17. FIG. 19 is a zoomed in portion of FIG. 18 showing the open stub capacitors C1-C3. Note that FIGS. 18 and 19 show the pole of the SP3T switch as being coupled to the transmission line, and phase change junctions J1-J3 that can be selectively controlled to be in conductive or nonconductive states, and thereby selectively couple the transmission line (single pole) to each capacitor, or decouple that capacitor.

To summarize, the tunable capacitive device 1750 (FIG. 17), which can be implemented in a section of the phase shifter device 100 of FIG. 2, for example, includes a capacitor bank having two SP3T switches to control six stubs (C1 to C6) connected in a single-port coplanar waveguide configuration, achieving high configurability without relying on grounded coplanar waveguide designs. By allowing any combination of the six capacitors to be activated independently, individually or simultaneously, the capacitor bank design enables 26=64 states, where each state corresponds to a specific combination of capacitances. In FIG. 2, there are three such capacitor banks, corresponding to Section 1-Section 3.

Each stub is connected via an SP3T switch to the main CPW line, which allows selective capacitance loading. In this example switch configuration, each SP3T switch has three positions per side, enabling seamless control of capacitors. State control is obtained by independent control of switches (junctions), resulting in a total of 64 available states, offering high flexibility for impedance matching and frequency tuning. Notwithstanding, capacitor banks with more (or fewer) open stub capacitors and/or multistate switches can be configured in a similar way, resulting in more than 64 available states (for finer tuning) or less than 64 available states (for coarser tuning).

Some example states (nine possible states of the sixty-four available with the example implementation of FIG. 17) are shown in the following table, TABLE 2:

TABLE 2

| State | Capacitors |
|---|---|
| A | C1 |
| B | C2 |
| C | C4 |
| D | C5 |
| E | C1 + C4 |
| F | C3 + C5 |
| G | C3 + C6 |
| H | C1 + C2 + C3 |
| I | C1 + C2 + C3 + C4 + C5 + C6 |

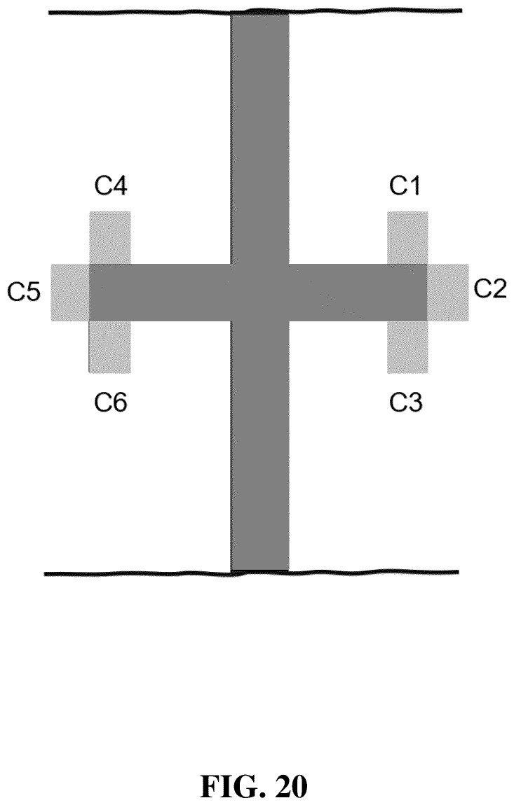

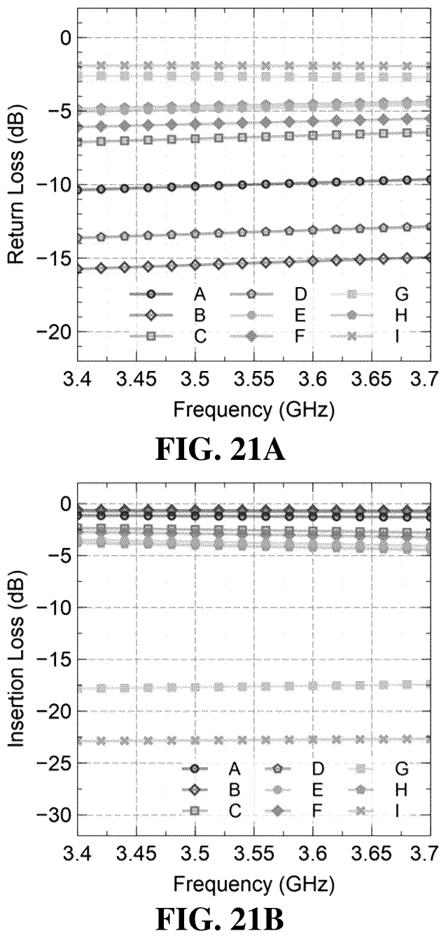

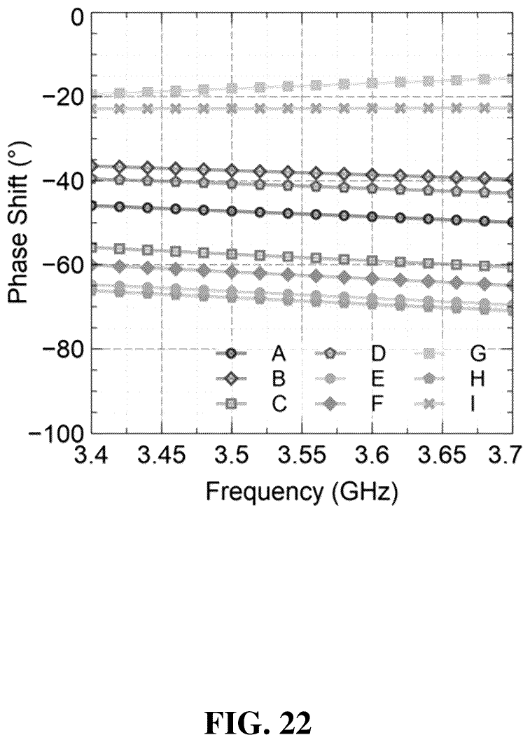

FIG. 20 is a top two-dimensional (2D) view of a scattering parameter (S-parameter) model of the example six capacitors of a capacitive device. FIG. 21A is a graphical representation of simulated return loss (in dB) with respect to different frequencies (from 3.4 to 3.7 GHZ) for the different states (described in the example states of TABLE 2) of the example capacitive device model. FIG. 21B is a graphical representation of simulated insertion loss (in dB) with respect to the different frequencies (from 3.4 to 3.7 GHZ) for the different example states of TABLE 2. FIG. 22 is a graphical representation of simulated phase shift (in degrees) with respect to the different frequencies (from 3.4 to 3.7 GHz) for the different states of the example capacitive device model.

One or more implementations can be embodied in a device, including a radio frequency (RF) input port, an RF output port, a signal transmission line set in including at least one main transmission line between the RF input port and the RF output port, respective phase shift transmission lines configured to be selectively coupled to the signal transmission line set by first respective RF switches, and respective true time delay transmission lines comprising respective stub capacitors configured to be selectively coupled to the signal transmission line set by second respective RF switches. The first respective RF switches are controllable to selectively couple zero or more of the respective phase shift transmission lines to the signal transmission line set to determine a first signal path, the second respective RF switches are controllable to selectively couple zero or more of the respective true time delay transmission lines to the signal transmission line set to determine a second signal path, and a combination of the first signal path and the second signal path determines an operational phase shift of the device applicable to an RF signal obtained at the RF input port and routed to the RF output port via the first signal path and the second signal path.

The respective phase shift transmission lines and the respective true time delay transmission lines can be configured as a co-coplanar waveguide lines.

The signal transmission line set can include a first main transmission line and a second main transmission line.

The phase shift transmission lines can include a first phase shift transmission line, a second phase shift transmission line, a third phase shift transmission line, and a fourth phase shift transmission line.

The first phase shift transmission line, the second phase shift transmission line, the third phase shift transmission line, and the fourth phase shift transmission line can correspond to phase shifts of twenty degrees or about twenty degrees, forty degrees or about forty degrees, sixty degrees or about sixty degrees, and one-hundred and twenty degrees or about one-hundred and twenty degrees, respectively.

The first phase shift transmission line and the second phase shift transmission line can be deployed proximate to the RF input port for selectively being coupled to the signal transmission line, and the third direct RF transmission line and the fourth direct RF transmission line can be deployed proximate to the RF output port for selectively being coupled to the signal transmission line.

The respective true time delay transmission lines can include a first subgroup of the respective true time delay transmission lines configured to be coupled to the signal transmission line set via a first subgroup of the second respective RF switches, and a second subgroup of the respective true time delay transmission lines configured to be coupled to the signal transmission line set via a second subgroup of the second respective RF switches.

The first subgroup can include a first true time delay transmission line, a second true time delay transmission line, and a third true time delay transmission line, and the first multistate RF switch can include a single-pole, three-throw switch that facilitates independent coupling of the RF transmission line to at least one of: the first true time delay transmission line, the true time delay transmission line, or the third true time delay transmission line.

The first switch subgroup can be incorporated into a first multistate RF switch, and wherein the second switch subgroup can be incorporated into a second multistate RF switch.

The first multistate RF switch can facilitate independent coupling of each true time delay transmission line to a first main transmission line of the signal transmission line set.

The first respective RF switches can include respective first phase change alloy material junctions, and the second respective RF switches can include respective second phase change alloy material junctions.

The respective phase change alloy material junctions can be controllable to be in respective conductive or nonconductive states based on: applying a first set pulse to a first subgroup of respective heating elements associated with the respective first phase change alloy material junctions to latch the first subgroup of the respective first phase change alloy material junctions into respective conductive states, applying a second set pulse to a second subgroup of respective heating elements associated with the respective second phase change alloy material junctions to latch the second subgroup of the respective second phase change alloy material junctions into respective conductive states, applying a first reset pulse to a third subgroup of respective heating elements associated with the respective first phase change alloy material junctions to latch the third subgroup of the respective first phase change alloy material junctions into respective nonconductive states, and applying a second reset pulse to a fourth subgroup of respective heating elements associated with the respective second phase change alloy material junctions to latch the fourth subgroup of the respective second phase change alloy material junctions into respective nonconductive states.

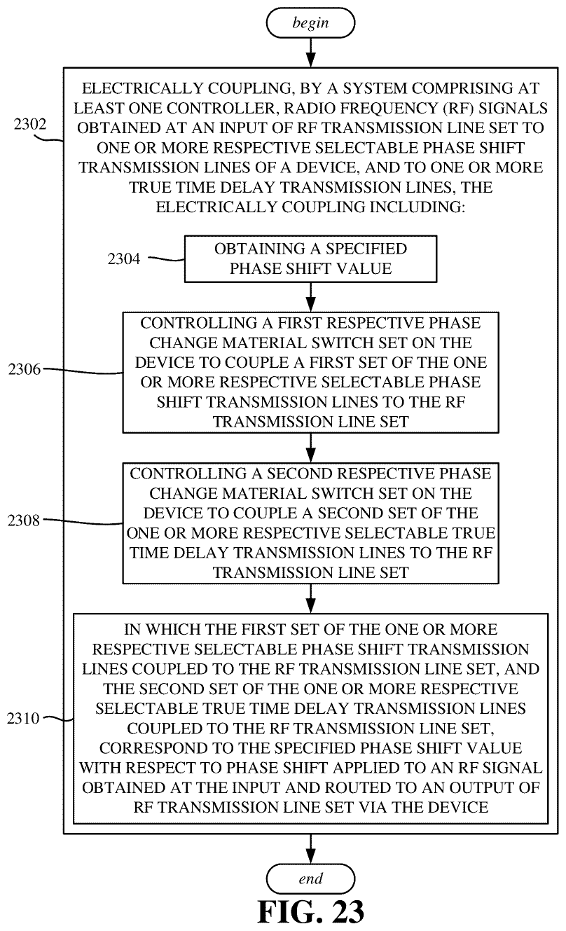

One or more example embodiments, implementations, and/or operations, such as corresponding to example operations of a method, can be represented in FIG. 23. Example operation 2302 represents electrically coupling, by a system including at least one controller, radio frequency (RF) signals obtained at an input of RF transmission line set to one or more respective selectable phase shift transmission lines of a device, and to one or more true time delay transmission lines, the electrically coupling can include example operations 2304-2310.

Example operation 2304 represents obtaining a specified phase shift value. Example operation 2306 represents controlling a first respective phase change material switch set on the device to couple a first set of the one or more respective selectable phase shift transmission lines to the RF transmission line set. Example operation 2308 represents controlling a second respective phase change material switch set on the device to couple a second set of the one or more respective selectable true time delay transmission lines to the RF transmission line set. Example block 2310 represents that the first set of the one or more respective selectable phase shift transmission lines coupled to the RF transmission line set, and the second set of the one or more respective selectable true time delay transmission lines coupled to the RF transmission line set, correspond to the specified phase shift value with respect to phase shift applied to an RF signal obtained at the input and routed to an output of RF transmission line set via the device.

The first respective phase change material switches can include respective phase change alloy switches, and controlling the first respective phase change material switch set can include applying a set energy pulse to set a first subgroup of the first respective phase change material switch set to respective conductive states, and applying a reset energy pulse to reset a second subgroup of the first respective phase change material switch set to respective nonconductive states.

The one or more respective selectable true time delay transmission lines can include a first true time delay transmission line of the one or more respective selectable true time delay transmission lines coupled to a first multistate switch of the first respective phase change material switch set, and a second true time delay transmission line of the one or more respective selectable true time delay transmission lines coupled to a second multistate switch of the first respective phase change material switch set; controlling the first respective phase change material switch set can include controlling a first state of the first multistate switch, and controlling a second state of the second multistate switch.

The one or more respective selectable phase shift transmission lines can include a first phase shift transmission line of the one or more respective selectable phase shift transmission lines coupled to a first multistate switch of the second respective phase change material switch set, and a second true time delay transmission line of the one or more respective selectable phase shift transmission lines coupled to a second multistate switch of the second respective phase change material switch set, and controlling the second respective phase change material switch set can include controlling a first state of the first multistate switch, and controlling a second state of the second multistate switch.

The specified phase shift value can be a first specified phase shift value, the RF signal can be a first RF signal, the phase shift applied to the first RF signal can be a first phase shift, and further operations can include obtaining, by the system, a second specified phase shift value, controlling, by the system, the first respective phase change material switch set on the device to couple a third set of the one or more respective selectable phase shift transmission lines to the RF transmission line set, and controlling, by the system, the second respective phase change material switch set on the device to couple a fourth set of the one or more respective selectable true time delay transmission lines to the RF transmission line set; the third set of the one or more respective selectable phase shift transmission lines coupled to the RF transmission line set, and the fourth set of the one or more respective selectable true time delay transmission lines coupled to the RF transmission line set, can correspond to the specified second phase shift value with respect to a second phase shift applied to a second RF signal obtained at the input and routed to an output of RF transmission line set via the device.

One or more implementations can be embodied in a tunable phase shift device. The tunable phase shift device can include a radio frequency (RF) input port, an RF output port, respective multistate RF switches, a first main RF signal transmission line coupled between the RF input port and the RF output port, and a second main RF signal transmission line coupled between the RF input port and the RF output port. The tunable phase shift device can include respective first phase shift transmission lines configured to be selectively coupled to the first main transmission line by a first group of the respective multistate RF switches, respective second phase shift transmission lines configured to be selectively coupled to the second main transmission line by a second group of the respective multistate RF switches, respective first true time delay transmission lines comprising respective first stub capacitors configured to be selectively coupled to the first signal transmission line set by a third group of the respective multistate RF switches, and respective second true time delay transmission lines comprising respective second stub capacitors configured to be selectively coupled to the first signal transmission line set by a fourth group of the respective multistate RF switches. To determine an operating phase shift of the tunable phase shift device with respect to RF signals routed from the RF input port to the RF output port via the first main RF transmission line and the second main RF transmission line, at least one controller can control respective first conductive or nonconductive states of the respective first group of the multistate RF switches to respectively couple or decouple the respective first phase shift transmission lines to the first main RF signal transmission line, respective second conductive or nonconductive states of the respective second group of the multistate RF switches to respectively couple or decouple the respective second phase shift transmission lines to the second main RF signal transmission line, respective third conductive or nonconductive states of the respective third group of the multistate RF switches to respectively couple or decouple the respective first true time delay transmission lines to the first main RF signal transmission line, and respective fourth conductive or nonconductive states of the respective fourth group of the multistate RF switches to respectively couple or decouple the respective second true time delay transmission lines to the second main RF signal transmission line.

The respective first phase shift transmission lines can include a first phase shift transmission line of the respective first phase shift transmission lines, the first phase shift transmission line configured to be selectively coupled to the first main transmission line by a first multistate RF switch set of the first group of the respective multistate RF switches, a third phase shift transmission line of the respective first phase shift transmission lines; the third phase shift transmission line can be configured to be selectively coupled to the first main transmission line by a third multistate RF switch set of the first group of the respective multistate RF switches, in which the respective second phase shift transmission lines can include a second phase shift transmission line of the respective second phase shift transmission lines, the second phase shift transmission line can be configured to be selectively coupled to the second main transmission line by a second multistate RF switch set of the second group of the respective multistate RF switches, and a fourth phase shift transmission line of the respective second phase shift transmission lines, the fourth phase shift transmission line can be configured to be selectively coupled to the second main transmission line by a fourth multistate RF switch set of the second group of the respective multistate RF switches.

The respective first true time delay transmission lines can include a first true time delay transmission line group of the respective first true time delay transmission lines, the first true time delay transmission line group configured to be selectively coupled to the first main transmission line by a first multistate RF switch group of the second group of the respective multistate RF switches, and a second true time delay transmission line group of the respective second true time delay transmission lines, the second true time delay transmission line group configured to be selectively coupled to the second main transmission line group by a second multistate RF switch group of the second group of the respective multistate RF switches.

As can be seen, the technology described herein facilitates a tunable phase shifter device in the form of selectable true time delay transmission lines and discrete switched open-stubs, which facilitate analog-type tuning by control of switch states. The combinations of fixed true time delay transmission lines and open-stub capacitors, e.g., arranged in sections, facilitate fine-grained, low-loss phase control. In one implementation, nonvolatile phase change material (e.g., GeTe) RF switches provide consistent phase states without the need for continuous power supply, improving energy efficiency. The result is an architecture that has a relatively small physical footprint, making the tunable phase shifter device suitable for applications in dense RF environments like 5G and satellite communication systems.

What has been described above include mere examples. It is, of course, not possible to describe every conceivable combination of components, materials or the like for purposes of describing this disclosure, but one of ordinary skill in the art can recognize that many further combinations and permutations of this disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A device, comprising:
a radio frequency (RF) input port;
an RF output port;
a signal transmission line set comprising at least one main transmission line between the RF input port and the RF output port;
respective phase shift transmission lines configured to be selectively coupled to the signal transmission line set by first respective RF switches;
respective true time delay transmission lines comprising respective stub capacitors configured to be selectively coupled to the signal transmission line set by second respective RF switches,
wherein the first respective RF switches are controllable to selectively couple zero or more of the respective phase shift transmission lines to the signal transmission line set to determine a first signal path,
wherein the second respective RF switches are controllable to selectively couple zero or more of the respective true time delay transmission lines to the signal transmission line set to determine a second signal path, and
wherein a combination of the first signal path and the second signal path determines an operational phase shift of the device applicable to an RF signal obtained at the RF input port and routed to the RF output port via the first signal path and the second signal path.

2. The device of claim 1, wherein the respective phase shift transmission lines and the respective true time delay transmission lines are configured as a co-coplanar waveguide lines.

3. The device of claim 1, wherein the signal transmission line set comprises a first main transmission line and a second main transmission line.

4. The device of claim 1, wherein the phase shift transmission lines comprises a first phase shift transmission line, a second phase shift transmission line, a third phase shift transmission line, and a fourth phase shift transmission line.

5. The device of claim 4, wherein the first phase shift transmission line, the second phase shift transmission line, the third phase shift transmission line, and the fourth phase shift transmission line correspond to phase shifts of twenty degrees or about twenty degrees, forty degrees or about forty degrees, sixty degrees or about sixty degrees and one-hundred and twenty degrees or about one-hundred and twenty degrees, respectively.

6. The device of claim 5, wherein the first phase shift transmission line and the second phase shift transmission line are deployed proximate to the RF input port for selectively being coupled to the signal transmission line, and wherein the third direct RF transmission line and the fourth direct RF transmission line are deployed proximate to the RF output port for selectively being coupled to the signal transmission line.

7. The device of claim 1, wherein the respective true time delay transmission lines comprise a first subgroup of the respective true time delay transmission lines configured to be coupled to the signal transmission line set via a first subgroup of the second respective RF switches, and a second subgroup of the respective true time delay transmission lines configured to be coupled to the signal transmission line set via a second subgroup of the second respective RF switches.

8. The device of claim 7, wherein the first subgroup comprises a first true time delay transmission line, a second true time delay transmission line, and a third true time delay transmission line, and wherein the first multistate RF switch comprises a single-pole, three-throw switch that facilitates independent coupling of the RF transmission line to at least one of: the first true time delay transmission line, the true time delay transmission line, or the third true time delay transmission line.

9. The device of claim 7, wherein the first switch subgroup is incorporated into a first multistate RF switch, and wherein the second switch subgroup is incorporated into a second multistate RF switch.

10. The device of claim 9, wherein the first multistate RF switch facilitates independent coupling of each true time delay transmission line to a first main transmission line of the signal transmission line set.

11. The device of claim 1, wherein the first respective RF switches comprise respective first phase change alloy material junctions, and wherein the second respective RF switches comprise respective second phase change alloy material junctions.

12. The device of claim 11, wherein the respective phase change alloy material junctions are controllable to be in respective conductive or nonconductive states based on:
applying a first set pulse to a first subgroup of respective heating elements associated with the respective first phase change alloy material junctions to latch the first subgroup of the respective first phase change alloy material junctions into respective conductive states;
applying a second set pulse to a second subgroup of respective heating elements associated with the respective second phase change alloy material junctions to latch the second subgroup of the respective second phase change alloy material junctions into respective conductive states;
applying a first reset pulse to a third subgroup of respective heating elements associated with the respective first phase change alloy material junctions to latch the third subgroup of the respective first phase change alloy material junctions into respective nonconductive states; and
applying a second reset pulse to a fourth subgroup of respective heating elements associated with the respective second phase change alloy material junctions to latch the fourth subgroup of the respective second phase change alloy material junctions into respective nonconductive states.

13. A method, comprising:
electrically coupling, by a system comprising at least one controller, radio frequency (RF) signals obtained at an input of RF transmission line set to one or more respective selectable phase shift transmission lines of a device, and to one or more true time delay transmission lines, the electrically coupling comprising:
obtaining a specified phase shift value;
controlling a first respective phase change material switch set on the device to couple a first set of the one or more respective selectable phase shift transmission lines to the RF transmission line set; and
controlling a second respective phase change material switch set on the device to couple a second set of the one or more respective selectable true time delay transmission lines to the RF transmission line set,
wherein the first set of the one or more respective selectable phase shift transmission lines coupled to the RF transmission line set, and the second set of the one or more respective selectable true time delay transmission lines coupled to the RF transmission line set, correspond to the specified phase shift value with respect to phase shift applied to an RF signal obtained at the input and routed to an output of RF transmission line set via the device.

14. The method of claim 13, wherein the first respective phase change material switches comprise respective phase change alloy switches, and wherein the controlling of the first respective phase change material switch set comprises applying a set energy pulse to set a first subgroup of the first respective phase change material switch set to respective conductive states, and applying a reset energy pulse to reset a second subgroup of the first respective phase change material switch set to respective nonconductive states.

15. The method of claim 13, wherein the one or more respective selectable true time delay transmission lines comprise a first true time delay transmission line of the one or more respective selectable true time delay transmission lines coupled to a first multistate switch of the first respective phase change material switch set, and a second true time delay transmission line of the one or more respective selectable true time delay transmission lines coupled to a second multistate switch of the first respective phase change material switch set, and wherein the controlling of the first respective phase change material switch set comprises controlling a first state of the first multistate switch, and controlling a second state of the second multistate switch.

16. The method of claim 13, wherein the one or more respective selectable phase shift transmission lines comprise a first phase shift transmission line of the one or more respective selectable phase shift transmission lines coupled to a first multistate switch of the second respective phase change material switch set, and a second true time delay transmission line of the one or more respective selectable phase shift transmission lines coupled to a second multistate switch of the second respective phase change material switch set, and wherein the controlling of the second respective phase change material switch set comprises controlling a first state of the first multistate switch, and controlling a second state of the second multistate switch.

17. The method of claim 13, wherein the specified phase shift value is a first specified phase shift value, wherein the RF signal is a first RF signal, wherein the phase shift applied to the first RF signal is a first phase shift, and further comprising:
obtaining, by the system, a second specified phase shift value;
controlling, by the system, the first respective phase change material switch set on the device to couple a third set of the one or more respective selectable phase shift transmission lines to the RF transmission line set; and
controlling, by the system, the second respective phase change material switch set on the device to couple a fourth set of the one or more respective selectable true time delay transmission lines to the RF transmission line set,
wherein the third set of the one or more respective selectable phase shift transmission lines coupled to the RF transmission line set, and the fourth set of the one or more respective selectable true time delay transmission lines coupled to the RF transmission line set, correspond to the specified second phase shift value with respect to a second phase shift applied to a second RF signal obtained at the input and routed to an output of RF transmission line set via the device.

18. A tunable phase shift device, comprising:
a radio frequency (RF) input port;
an RF output port;
respective multistate RF switches;
a first main RF signal transmission line coupled between the RF input port and the RF output port;
a second main RF signal transmission line coupled between the RF input port and the RF output port;
respective first phase shift transmission lines configured to be selectively coupled to the first main transmission line by a first group of the respective multistate RF switches;
respective second phase shift transmission lines configured to be selectively coupled to the second main transmission line by a second group of the respective multistate RF switches;
respective first true time delay transmission lines comprising respective first stub capacitors configured to be selectively coupled to the first signal transmission line set by a third group of the respective multistate RF switches; and
respective second true time delay transmission lines comprising respective second stub capacitors configured to be selectively coupled to the first signal transmission line set by a fourth group of the respective multistate RF switches,
wherein, to determine an operating phase shift of the tunable phase shift device with respect to RF signals routed from the RF input port to the RF output port via the first main RF transmission line and the second main RF transmission line, at least one controller controls:
respective first conductive or nonconductive states of the respective first group of the multistate RF switches to respectively couple or decouple the respective first phase shift transmission lines to the first main RF signal transmission line;
respective second conductive or nonconductive states of the respective second group of the multistate RF switches to respectively couple or decouple the respective second phase shift transmission lines to the second main RF signal transmission line;
respective third conductive or nonconductive states of the respective third group of the multistate RF switches to respectively couple or decouple the respective first true time delay transmission lines to the first main RF signal transmission line; and
respective fourth conductive or nonconductive states of the respective fourth group of the multistate RF switches to respectively couple or decouple the respective second true time delay transmission lines to the second main RF signal transmission line.

19. The tunable phase shift device of claim 18, wherein the respective first phase shift transmission lines comprise:
a first phase shift transmission line of the respective first phase shift transmission lines, the first phase shift transmission line configured to be selectively coupled to the first main transmission line by a first multistate RF switch set of the first group of the respective multistate RF switches,
a third phase shift transmission line of the respective first phase shift transmission lines, the third phase shift transmission line configured to be selectively coupled to the first main transmission line by a third multistate RF switch set of the first group of the respective multistate RF switches; and
wherein the respective second phase shift transmission lines comprise:
a second phase shift transmission line of the respective second phase shift transmission lines, the second phase shift transmission line configured to be selectively coupled to the second main transmission line by a second multistate RF switch set of the second group of the respective multistate RF switches, and
a fourth phase shift transmission line of the respective second phase shift transmission lines, the fourth phase shift transmission line configured to be selectively coupled to the second main transmission line by a fourth multistate RF switch set of the second group of the respective multistate RF switches.

20. The tunable phase shift device of claim 18, wherein the respective first true time delay transmission lines comprise:
a first true time delay transmission line group of the respective first true time delay transmission lines, the first true time delay transmission line group configured to be selectively coupled to the first main transmission line by a first multistate RF switch group of the second group of the respective multistate RF switches; and
a second true time delay transmission line group of the respective second true time delay transmission lines, the second true time delay transmission line group configured to be selectively coupled to the second main transmission line group by a second multistate RF switch group of the second group of the respective multistate RF switches.
